(19) United States
(12) Patent Application Publication
(10) Pub. No.: US 2004/0205578 A1
(43) Pub. Date: Oct. 14, 2004

(54) System and method for converting document to reusable learning object

(76) Inventors: Alan S. Wolff, Louisville, CO (US); Carol Harrisville-Wolff, Louisville, CO (US); Jeff S. Demoff, Erie, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/131,982

(22) Filed: Apr. 25, 2002

(51) Int. Cl. G06F 17/24

(52) U.S. Cl. 715/513; 707/201; 715/523

(57) ABSTRACT

A system and method for converting a document to create a reusable learning object is disclosed. The reusable learning object is used to create a course of instruction for an online or virtual classroom. The reusable learning object is shared and modified by different users for each course. A document stored on a computing platform coupled to the system is made available for the reusable learning object. The document is created by an application and contains data that may not be in a format useable by the reusable learning object. An autopilot and an export filter are invoked by a prompt or command from the application or another source. The export filter converts the data within the document into metadata to support an extensible markup language (“XML”) format. The autopilot queries and receives information on the document to create the reusable learning object. The reusable learning object is created by the converted data and received information. Thus, the document is available for online training purposes despite not being in a format supported by the reusable learning object.

### BACKGROUND OF THE INVENTION

1. Field of the Invention

The present invention relates to preparing documents for use within a computer or network, and more particularly, the invention relates to using an export filter to covert prepared document of a particular format into a reusable learning object.

2. Discussion of the Related Art

With the proliferation on online research, the opportunity for education and training through online systems is increasing. Users are able to access training materials and courses over networks without being located physically with other users or in a classroom. These training activities may be implemented using learning management systems (“LMSs”) that help manage online training for large companies and enterprises. An administrator can prepare courses for students using the LMS, and the students can access the courses at a website or other virtual location. The LMS can track the number of students, their progress in the course materials, administer tests, and the like.

Online training systems, including an LMS, may use reusable learning objects in preparing and configuring the online courses. Reusable learning objects (“RLOs”) may be of any size and topic. RLOs may be discreet sections of training that is placed with other RLOs to create a course of instruction. RLOs may be used by other entities besides the creator, and reused a number of times. RLOs, however, should be written according to consistent standards and specification defined by the LMSs.

An LMS using RLOs may desire to be compliant with any applicable standards for creating the RLOs. Thus, any RLO prepared to the standard may be delivered within an online or computer educational environment and used in structuring a course. Typically, RLOs are created by designers familiar with the applicable standards and designing RLOs. This process, however, may be cost prohibitive as expertise and specific design systems are desired for creating the RLOs.

Organizations have a wealth of untapped existing materials suitable for RLOs in prepared presentations, papers, articles, and other resources that are created in an everyday environment for presentations, meetings, and the like. These materials are not created for use as online training materials, but can be used in a course of instruction if combined with other materials. For example, a manager may prepare a presentation for a group using a spreadsheet or slide presentation application. The presentation may not be considered as an online training resource until combined with other presentations. Further, the materials may be documents that are not prepared using the standardized specifications desired to create RLOs.

### SUMMARY OF THE INVENTION

Accordingly, the disclosed embodiments are directed to a system and method for converting documents into reusable learning objects.

Additional features and advantages of the invention will be set forth in the disclosure that follows, and in part will be apparent from the disclosure, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system for converting a document to a reusable learning object is disclosed. The reusable learning object is configured for training over a network. The system includes an application to create the document. The document contains data. The system also includes an autopilot to query and receive information about the document. The system also includes an export filter to convert the data within the document into metadata, such that the converted document contains extensible markup language that is incorporated by the reusable learning object.

According to another embodiment, a method for creating a reusable learning object from a document is disclosed. The method includes invoking an autopilot and an export filter. The method also includes receiving a document having data. The method also includes responding to the autopilot to provide information regarding the document. The method also includes converting the data into metadata using the export filter. The method also includes generating the reusable learning object using the metadata and the information from the autopilot.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates a block diagram of an online training system in accordance with an embodiment of the present invention.

FIG. 2 illustrates a flowchart for converting a document to create a reusable learning object in accordance with an embodiment of the present invention.

FIG. 3 illustrates a flowchart for creating a course for online training in accordance with an embodiment of the present invention.

### DETAILED DESCRIPTION OF THE PREFERRED EMBODIMENTS

Reference will now be made in detail to the preferred embodiment of the present invention, examples of which are illustrated in the accompanying drawings.

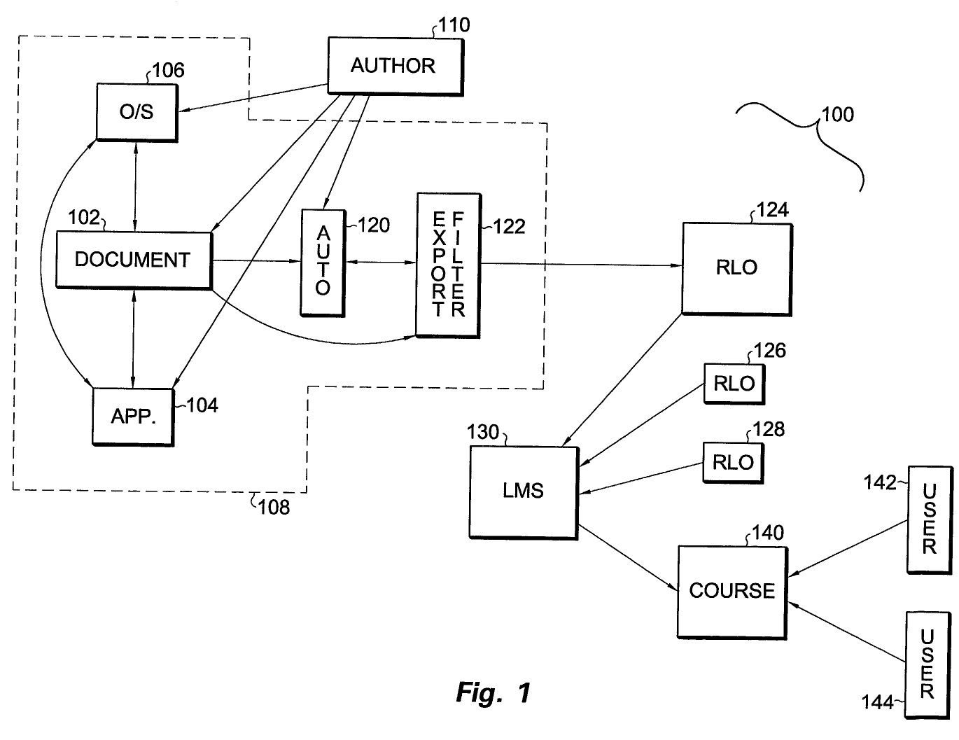

FIG. 1 depicts a block diagram of an online training system 100 in accordance with an embodiment of the present invention. Online training system 100 provides instruction, courses, materials, and the like to users, such as users 142 and 144. Online training system 100 may be known as a virtual classroom environment because students, or users, may access courses and materials from various locations. Online training system 100 may be a network of computing platforms, such as desktops, laptops, workstations, nodes, personal digital assistants, wireless devices, telephones, and the like. Online training system 100 may be implemented over the Internet or an intranet within an organization. Online training system 100, however, does not require the computing platforms to be in different locations. A classroom setting also may utilize online training system 100 to provide instruction to users.

Online training system 100 includes computing platform 108. Computing platform 108 executes an operating system 106 to run an application 104. Computing platform 108 may include a processor and a memory coupled to the processor. The memory stores instructions to be executed on the processor, including processes to execute and support operating system 106 and application 104. Application 104 creates or accesses a document 102. Document 102 preferably contains information such as text, graphics, sounds, and the like. Author 110 creates or modifies document 102 using application 104. Document 102 is created and modified according to a format supported by application 104. For example, if application 104 is a word processing application, then document 102 is supported and compatible with the format used by application 104. According to this example, document 102 may not be supported by other word processing applications supported by operating system 106 and computing platform 108.

Further, computing platform 108 may access a number of documents created by different applications supported by operating system 106. Author 110 uses application 104 or other applications to open and edit the documents. Document 102 may be sent to other computing platforms within online training system 100. Preferably, computing platform 108 is coupled to a network that supports online training system 100, as well as other systems and services. Thus, computing platform 108 may be a workstation or computer for an employee of a company that supports a network for information exchange. The services for the network include online training system 100. In other words, document 102 should not be prepared for use in online training system 100.

Online training system 100 also includes LMS 130. LMS 130 allows users 142 and 144 to receive training and education. Specifically, users 142 and 144 may enroll and take course 140. Course 140 may be a class, training session, seminar and the like. Course 140 is comprised of RLOs, and is configured using LMS 130. LMS 130 may enroll and monitor users 142 and 144 in course 140. LMS 130 also may administer tests and other feedback operations for course 140. Alternatively, course 140 may perform these tasks. Online training system 100 is not limited to users 142 and 144. Any number of users may enroll and participate in course 140 via LMS 140.

LMS 130 uses RLOs to construct course 140. Preferably, RLOs are shareable between different LMSs. For example, LMS 130 may select RLOs 124, 126, and 128 to create course 140. LMS 130 may be a system, program, and the like, and may be located on a computing platform, such as a server, computer, desktop and the like. An administrator may use LMS 130 to create course 140, or LMS may automatically select and configure RLOs 124, 126, and 128 in response to a request from online training system 100.

Author 110 may desire to convert document 102 into a reusable learning object for use by LMS 130. As disclosed above, document 102 may be created and stored in a format supported by application 104. The format may not be compatible with the standardized format desired used by LMS 130 for RLOs. To create course 140, LMS 130 uses RLOs prepared according a standardized specification. Thus, document 102 should be converted to the proper format to be compatible with the specification corresponding to LMS 130.

Computing platform 108 supports autopilot 120 and export filter 122 to convert document 102 into RLO 124. Autopilot 120 and export filter 122 may reside within application 104, or invoked by operating system 106 to support creating RLO 124. Autopilot 120 may be a plurality of autopilots that act as wizards, or interfaces, that help users, such as author 110, complete complex tasks using a series of questions, menu selections, and option choices determined by application 104. Autopilot 120 may assist in eliciting the information desired to create RLO 124. RLO 124 may need specific information not supplied by document 102 itself, such as any data necessary to qualify as compliant for LMS 130. This information may include, for example, title, type of RLO, subject matter, and the like. Autopilot 120 allows author 110 to create RLO 124 without any specific knowledge or experience in the specifications desired by LMS 130. Author 110 answers the prompts given by autopilot 120 to complete the conversion operations for document 102.

Export filter 122 takes the content of document 102 and converts it to an extensible markup language (“XML”) format. An XML format is a flexible format to create and share data between different systems. The XML format also allows computing platform 108 to share RLO 124 with other components within online training system 100, including LMS 130. Thus, document 102 becomes an open document using metadata associated with the XML format. As metadata, document 102 may be exchanged, modified, and reviewed by other components and systems in a consistent manner.

RLO 124 is created by incorporating the converted document 102. An administrator or user, such as author 110, may add data to RLO 124 through Autopilot 120 in XML format to indicate that RLO 124 is a learning object, its subject matter, and any other pertinent information. This additional data is desired so LMS 130 can identify and process RLO 124 properly. Further, because document 102 has been converted into metadata for RLO 124, LMS 130 may display RLO 124 to online training system 100.

Preferably, the RLO conversion process is prompted by a command from author 110 within application 104 to use autopilot 120 and export filter 122. The conversion process may occur at any time. The resulting metadata version of document 102 then may be stored on computing platform 108, and the creation of RLO 124 may occur later. Alternatively, autopilot 120 and export filter 122 may be invoked with the use of application 102, and may be prompted via operating system 106. Computing platform 108 may retrieve document 102 from memory and perform the conversion process without opening application 104.

Thus, author 110 may take any document 102 and create RLO 124, even if document 102 does not meet the standardized specification requirements of LMS 130. Document 102 may be converted into an XML format having metadata by invoking autopilot 120 and export filter 122. Using the prompts from autopilot 120, RLO 124 is created according to the desires of author 110, but in a format readable by LMS 130. LMS 130 then may make RLO 124 available for online training system 100.

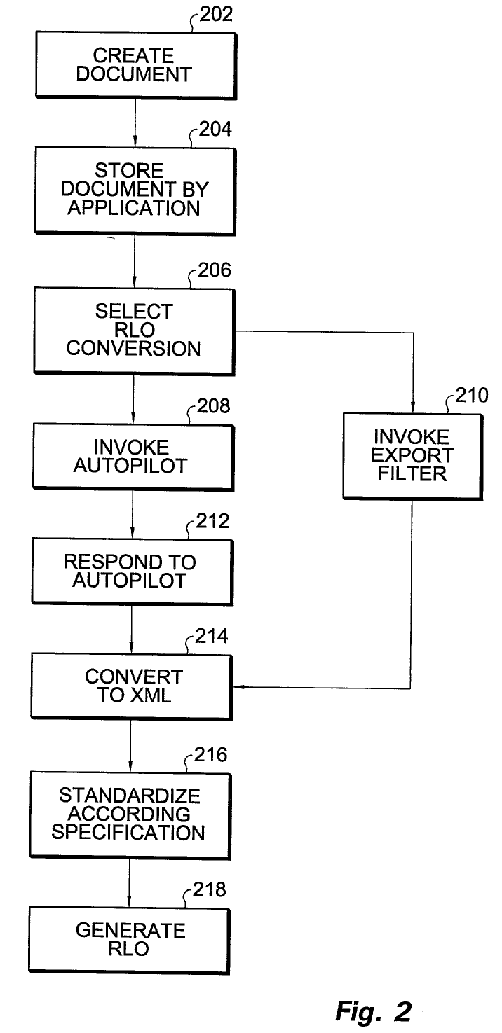

FIG. 2 depicts a flowchart for converting a document into a reusable learning object in accordance with an embodiment of the present invention. The steps of the flowchart disclosed in FIG. 2 make reference to features disclosed in FIG. 1, but the embodiments disclosed by FIG. 2 are not limited to features disclosed with reference to FIG. 1. Further, the implementation of the embodiments disclosed by FIG. 1 are not limited to the features disclosed with reference to FIG. 2.

Step 202 executes by creating document 102 using application 104. Author 110 may create document 102 by entering data, text, graphics, or other information into document 102. Application 102 creates document 102 according to a format supported by application 102. This format may be closed so that document 102 is not readily shareable with other applications across online training system 100. Step 204 executes by storing document 102 on computing platform 108. Preferably, document 102 is stored within memory and is accessible by computing platform 108, operating system 106, or application 104. Step 206 executes by selecting document 102 for conversion to XML format to create RLO 124. Document 102 may be in the format of application 104, and needs to be converted to an XML format.

Step 208 executes by invoking autopilot 120 to prompt author 110 into providing information to create RLO 124 from document 102. Autopilot 120 may act as a wizard, or graphical user interface, on a display or other means of communication to elicit the information. Step 210 executes by invoking export filter 122 to convert the information and data within document 102. Step 212 executes by responding to the questions and queries from autopilot 120. Autopilot 120 queries for information needed to create RLO 124. Step 214 executes by converting the data and information in document 102 into metadata suitable for the XML format. Step 216 executes by standardizing the metadata according to the specification used by an appropriate LMS, such as LMS 130. Further, the information retrieved by autopilot 120 may be incorporated into the metadata. Step 218 executes by generating RLO 124 from the metadata and added information. RLO 124 may be used alone or in conjunction with other RLOs to create a course of instruction using LMS 130 for use on online training system 100.

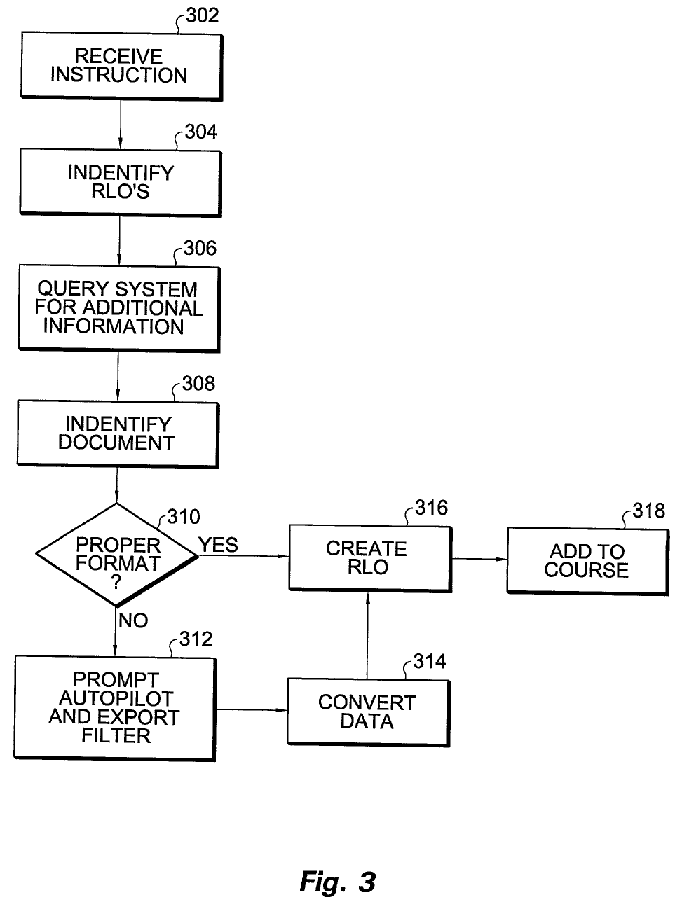

FIG. 3 depicts a flowchart for creating a course using RLOs in accordance with an embodiment of the present invention. The steps of the flowchart disclosed in FIG. 3 will make reference to features disclosed in FIG. 1, but the embodiments disclosed by FIG. 3 are not limited to features disclosed with reference to FIG. 1. Further, the implementation of the embodiments disclosed by FIG. 1 are not limited to the features disclosed with reference to FIG. 3.

Step 302 executes by receiving an instruction at LMS 130 to create a course of instruction, such as course 140, to be made available over online training system 100. The instruction may be sent by a user, administrator, and the like of online training system 100 or a network coupled to system 100. Step 304 executes by identifying RLOs to create course 140, such as RLOs 126 and 128. RLOs 126 and 128 are available to LMS 130 from any location and meet the specifications desired by LMS 130.

Step 306 executes by querying online training system 100 for additional information to complete course 140. For example, LMS 130 may determine that additional course material would be desirable, but no RLO is available on the subject. A message or other type of query may be sent to users and computing platforms asking for materials on the subject matter, such as articles, presentations, spreadsheets, graphics, and the like. Step 308 executes by identifying document 102 as suitable for course 140. Document 102 may include subject matter or data pertinent to course 140.

Step 310 executes by determining whether document 102 is in the proper format to meet the specification and requirements of LMS 130. LMS 130 may not be able to incorporate, share or display document 102 if it is not compatible with the standardized specification. Preferably, the proper format for LMS 130 is an XML format with the document having metadata. If yes, then step 316 executes as disclosed below. If no, then step 312 executes by prompting a conversion process using autopilot 120 and export filter 122. Autopilot 120 and export filter 122 may reside in application 104, operating system 106, or computing system 108. The conversion process may be initiated by author 110 of document 102, or LMS 130. Step 314 executes by converting the data within document 102 into metadata according to the XML format desired by LMS 130. Further, autopilot 120 retrieves additional information to create an RLO from the converted metadata of document 102.

Step 316 executes by creating RLO 124 from the information gathered by autopilot 120 and the metadata converted by export filter 122. RLO 124 may be a shareable object for use within online training system 100. Step 318 executes by adding RLO 124 to course 140.

Thus, companies, institutions, and any organization having different documents on training, expertise, and the like may use those documents in creating online courses. A wealth of subject matter can be tapped by anyone within the organization to create an RLO from an existing document that is not compatible with an LMS without using designers, programmers, software programs, and the like. The disclosed embodiments are applicable to existing systems and applications. Therefore, the creation of RLOs may be optimized and increased, and the cost associated with constructing courses for online training may be reduced.

It will be apparent to those skilled in the art that various modifications and variations can be made in the present invention without departing from the spirit or scope of the invention. Thus, it is intended that the disclosed embodiments cover the modifications and variations of this invention provided that they come within the scope of any claims and their equivalents.

What is claimed:

1. A system for converting a document to a reusable learning object, wherein said reusable learning object is configured for training over a network, comprising:
an application to create said document, wherein said document contains data;
an autopilot to query and receive information about said document; and
an export filter to convert said data within said document into metadata, such that said converted document contains extensible markup language that is incorporated by said reusable learning object.

2. The system of claim 1, wherein said autopilot and said export filter are invoked by said application.

3. The system of claim 1, further comprising a computing platform to support said application, said autopilot and said export filter.

4. The system of claim 3, further comprising an operating system on said computing platform to invoke said autopilot and said export filter.

5. The system of claim 1, further comprising a learning management system that uses said reusable learning object.

6. The system of claim 1, wherein said reusable learning object includes said data from said document as metadata.

7. The system of claim 1, further comprising an user that accesses said reusable learning object via a learning management system.

8. A system for converting data of a document into metadata for use in a reusable learning object, comprising:
an operating system supporting an application to create said document using said data;
an autopilot to query for information about said document;
an export filter to convert said data in said metadata to support an extensible markup language format acceptable to a learning management system; and
a computing platform to support said operating system and said application, and provides a location to store said document, wherein said autopilot and said export filter are invoked on said computing platform.

9. The system of claim 8, wherein said autopilot and said export filter are invoked according to a command received at said application.

10. The system of claim 8, wherein said autopilot and said export filter are invoked according to a command received at said operating system.

11. The system of claim 8, wherein said metadata allows said document to be open ended.

12. A method for creating a reusable learning object from a document, comprising:
invoking an autopilot and an export filter;
receiving a document having data;
responding to said autopilot to provide information regarding said document;
converting said data into metadata using said export filter; and
generating said reusable learning object using said metadata and said information from said autopilot.

13. The method of claim 12, further comprising creating said document using an application.

14. The method of claim 13, wherein said invoking includes receiving a prompt from said application.

15. The method of claim 12, further comprising retrieving said document.

16. The method of claim 12, further comprising standardizing said metadata to support an extensible markup language format.

17. A method for creating a course using reusable learning objects with a learning management system, comprising:
receiving a document having data;
determining whether said document has an extensible markup language format;
invoking an export filter to convert said data within document to metadata supporting said extensible markup language format; and
creating a reusable learning object using said metadata.

18. The method of claim 17, further comprising invoking an autopilot for query for information on said document.

19. The method of claim 17, further comprising adding said reusable learning object to a course using said learning management system.

20. The method of claim 17, further comprising querying a plurality of documents for said document.

21. A method for converting a document having data according to a format to a reusable learning object, comprising:
selecting said document;
receiving a prompt to convert said document to an extensible markup language format;
invoking an export filter;
converting said data within said document to metadata corresponding to said extensible markup language format;
invoking an autopilot to receive information on said document to supplement said metadata; and
creating said reusable learning object having said extensible markup language format with said metadata and said information from said autopilot.

22. The method of claim 21, further comprising determining whether said format is said extensible markup language format.

23. The method of claim 21, further comprising standardizing said metadata according to a specification for said reusable learning object.

24. The method of claim 21, further comprising creating said document with an application supporting said format.

25. The method of claim 24, wherein said application is a closed application.

26. A system for method for creating a reusable learning object from a document, comprising:
means for invoking an autopilot and an export filter;
means for receiving a document having data;
means for responding to said autopilot to provide information regarding said document;
means for converting said data into metadata using said export filter; and
means for generating said reusable learning object using said metadata and said information from said autopilot.

27. A computer program product comprising a computer useable medium having computer readable code embodied therein for creating a reusable learning object from a document, the computer program product adapted when run on a computer to execute steps, including:
invoking an autopilot and an export filter;
receiving a document having data;
responding to said autopilot to provide information regarding said document;
converting said data into metadata using said export filter; and
generating said reusable learning object using said metadata and said information from said autopilot.

28. A system for creating a course using reusable learning objects with a learning management system, comprising:
means for receiving a document having data;
means for determining whether said document has an extensible markup language format;
means for invoking an export filter to convert said data within document to metadata supporting said extensible markup language format; and
means for creating a reusable learning object using said metadata.

29. A computer program product comprising a computer useable medium having computer readable code embodied therein for creating a course using reusable learning objects with a learning management system, the computer program product adapted when run on a computer to execute steps, including:
receiving a document having data;
determining whether said document has an extensible markup language format;
invoking an export filter to convert said data within document to metadata supporting said extensible markup language format; and
creating a reusable learning object using said metadata.

30. A system for converting a document having data according to a format to a reusable learning object, comprising:
means for selecting said document;
means for receiving a prompt to convert said document to an extensible markup language format;
means for invoking an export filter;
means for converting said data within said document to metadata corresponding to said extensible markup language format;
means for invoking an autopilot to receive information on said document to supplement said metadata; and
means for creating said reusable learning object having said extensible markup language format with said metadata and said information from said autopilot.

31. A computer program product comprising a computer useable medium having computer readable code embodied therein for converting a document having data according to a format to a reusable learning object, the computer program product adapted when run on a computer to execute steps, including:
selecting said document;
receiving a prompt to convert said document to an extensible markup language format;
invoking an export filter;
converting said data within said document to metadata corresponding to said extensible markup language format;
invoking an autopilot to receive information on said document to supplement said metadata; and
creating said reusable learning object having said extensible markup language format with said metadata and said information from said autopilot.
